(19) United States
(12) Patent Application Publication
(10) Pub. No.: US 2011/0053505 A1
(43) Pub. Date: Mar. 3, 2011

(54) Portable distress device with a bluetooth signal

(75) Inventor: Chih-Ping Fang, Keelung City (TW)

(73) Assignee: Hua Shuay Enterprise Co., Ltd.

(21) Appl. No.: 11/826,042

(22) Filed: Jul. 11, 2007

(51) Int. Cl. H04B 7/00

(52) U.S. Cl. 455/41.2

(57) ABSTRACT

A portable distress device with a Bluetooth signal includes a control unit, a power unit, a Bluetooth signal control module, and an I/O control unit. When the I/O control unit activates an input signal, the control unit first controls the Bluetooth signal control module and the I/O control unit to issue an alarm and a distress signal. In a fixed time after activating the distress signal, without releasing from a distress condition, a low frequency heart beat simulator will be activated automatically, to generate sound like a human heart beat. The Bluetooth signal control module contains a Bluetooth signal transmitter which may or may not require a pair matching, enabling any product, such as a notebook computer, a cellular phone, and a PDA, which is equipped with a device for receiving the Bluetooth signal, to be used as a life searching receiver to proceed with the rescue.

### BACKGROUND OF THE INVENTION

a) Field of the Invention

The present invention relates to a portable distress device with a Bluetooth signal, and more particularly to a distress device which is portable, practical, and widely applied, as well as can be used as a required personal deployment for sending out a distress signal by a mountain climber, a person who works in a dangerous situation, or a person who needs help. The portable distress device is provided with a Bluetooth signal control module and a Bluetooth signal transmitter for which a pair matching may or may not be required, such that any product that is provided with a Bluetooth signal receiving device, for example, a notebook computer, a cellular phone, or a PDA (Personal Digital Assistant), can be used as a life searching receiver. When the life searching receiver receives a signal, a dedicated icon (such as SOS(Save Our Soul)), and an independent sequence number will be shown on a screen, without confusing with icons of other Bluetooth products, which allows a rescuer to clearly identify for proceeding with the rescue.

b) Description of the Prior Art

In spite of advancement of technology, natural disasters are still inevitable under the modern technology. Due to recent incidences of major catastrophes, such as earthquake, tsunami, how to save us or to save other people has become an important issue. When a disaster occurs, we all can be victims or rescuers.

Most of signals of conventional distress devices are transmitted by radio wave. However, this kind of signal transmission is a passive mode in that the signal transmitted by the radio wave has a certain frequency, and a rescuer has to carry a receiver that can receive the signal at that frequency to identify an accurate location of a victim who sends out a distress signal. Moreover, a ray which is sent out from the distress signal is not commonly provided with strong penetrating power; therefore, it is easy to be blocked by buildings, rubbles, or mountains to affect quality of reception. Accordingly, even that the distress device is sending out the signal, it is still not able to satisfy requirements of convenience, flexibility, and practicability.

Accordingly, how to remove the inconvenience caused by inflexibility in application, due to that the conventional deployment with radio transmission is not easy to allow a receiver to accurately receive a distress message, is a technical issue to be solved.

### SUMMARY OF THE INVENTION

The primary object of the present invention is to provide a portable distress device with a Bluetooth signal to effectively avoid the shortcoming of the aforementioned distress device by radio transmission, so as to provide good practicability. By using a feature that a Bluetooth signal has strong penetrating power of 2.45 GHz (Gigahertz) without being interfered by an electromagnetic wave, in association with software program control, sound of alarm and an icon of a distress signal can be issued to enable a product, such as a computer, a cellular phone, or a PDA, which is equipped with a Bluetooth signal receiving chipset to be used as a life searching receiver, without requiring special equipment to receive the distress signal, thereby increasing rescue efficiency and time, and gaining survival chance for a victim, which will further improve a conventional rescuing mode that wastes time, labor, and is low efficient.

Another object of the present invention is to provide a portable distress device with a Bluetooth signal, wherein in a certain fixed time after activating the distress device without releasing from a distress condition, a low frequency heart beat simulator will be automatically activated to gain more survival chance for the victim.

Accordingly, the present invention provides a portable distress device with a Bluetooth signal, which is used as a required personal deployment for issuing a distress signal by a mountain climber, a person who works in a dangerous situation, or a person who is trapped in rubbles of a building from an earthquake, and thus requiring to be rescued. The distress device includes at least a control unit which controls a Bluetooth signal control module and an I/O (Input/Output) control unit to issue an alarm and a distress signal after an input signal is activated by the I/O control unit; a power unit which is provided with a power supply design for a golden rescue time of 72 hours, to gain the rescue time; the Bluetooth signal control module, a Bluetooth chip of which operates on a bandwidth of 2.45 GHz for transmission, and a signal design of which may or may not require a pair matching; and the I/O control unit, which includes the input signal that activates or deactivates a distress procedure, and an output signal that issues the alarm and the distress signal.

In a certain fixed time after the input signal has been activated by the distress device without releasing from the distress condition, the control unit will automatically activate a low frequency heart beat simulator to generate sound like a human heart beat, allowing a rescue dog, with a hearing range between 15 to 50,000 Hz (Hertz), and a life detector to search for the victim, thereby gaining more survival chance for the victim.

On the other hand, as the present invention is installed with a Bluetooth signal transmitter for which a pair matching may not be required, the Bluetooth signal transmitter can transmit sound and images, as well as digital data. Each Bluetooth connection device is provided with a 48-bit address specified by the IEEE (Institute of Electrical and Electronic Engineers) 802 standard, can be connected by a one-to-one or one-to-many connection, with a transmission range as far as 10 m to 100 m, and is not interfered by an electromagnetic wave. As a Bluetooth device uses a low power, it will not harm a human body at all. In addition, as being a universal standard for the Bluetooth technology, any portable terminal, including communication, information, or media product (consumer product, for example, a cellular phone, a PDA, a computer, and other related electronic product) can receive the distress message. The present invention also allows two devices to transmit data wirelessly, under a condition that they are not aligned in a straight line. Therefore, any product, such as a notebook computer, a cellular phone, and a PDA, can be used as a life searching receiver, to proceed with the rescue more quickly, as long as that it is equipped with a device for receiving the Bluetooth signal.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a logic circuit of the present invention.

FIG. 2 shows a schematic view of a work flow of the present invention.

### DETAILED DESCRIPTION OF THE PREFERRED EMBODIMENTS

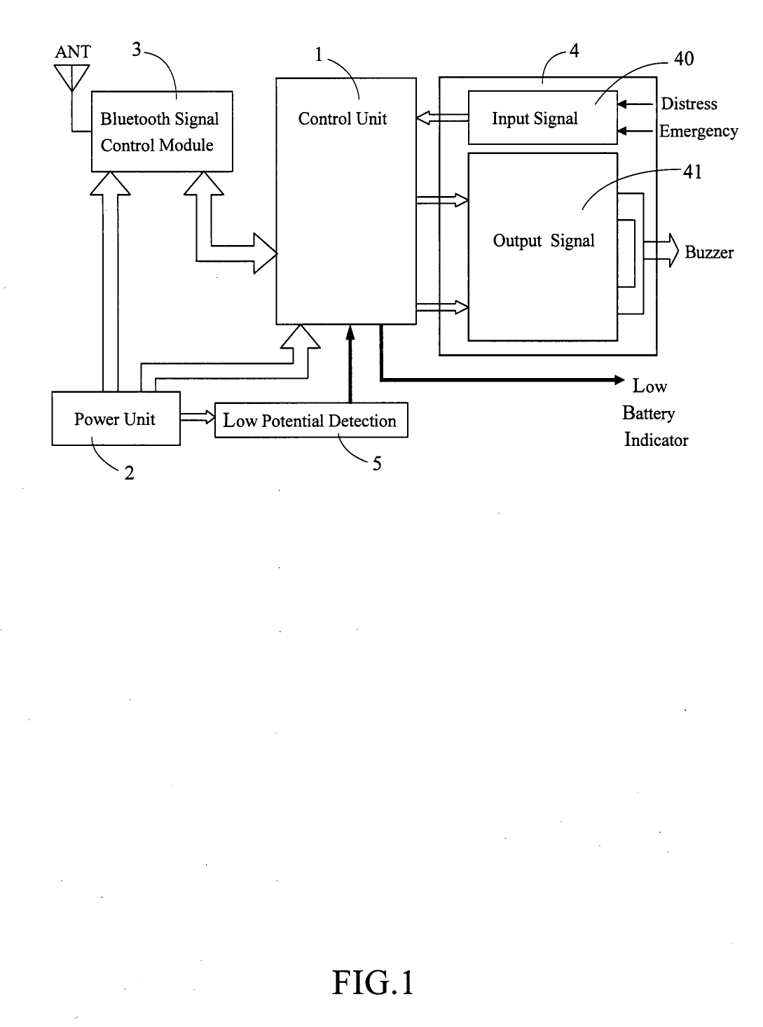

Referring to FIG. 1, a portable distress device with a Bluetooth signal of the present invention includes a control unit 1 which is provided with a controlling CPU (Central Processing Unit) to control the entire distress device, wherein after an input signal which initiates a distress procedure is entered, a Bluetooth signal control module 3 will be controlled first to transmit sound, images, and related digital data, as well as to issue an alarm and a distress signal through an I/O control unit 4.

In addition, in a certain fixed time after the input signal has been activated by the distress device, without releasing from a distress condition, a controlling CPU of the control unit 1 will, under control of a timer, control and activate a low frequency heart beat simulator to generate sound like a human heart beat.

The distress device is also provided with a power unit 2 which supplies the power required by the entire distress device. The power unit 2 itself is provided with a power supply design for a golden rescue time of 72 hours, to gain the rescue time. In addition, the power unit 2 itself is also provided with a function of low potential detection 5, and a low potential warning display design.

A Bluetooth chip of the Bluetooth signal control module 3 operates on a bandwidth of 2.45 GHz for transmission, and a signal design of the Bluetooth signal control module 3 does not require a pair matching, but to take a 48-bit address which is specified by the IEEE 802 standard for connecting messages by a one-to-one or one-to-many connection, with a transmission range as far as 10 m to 100 m. As a universal standard for the distress signal issued by the Bluetooth technology, any portable terminal, including communication, information, or media product (consumer product, for example, a cellular phone, a PDA, a computer, or other related electronic product), as long as that it is equipped with a device for receiving the Bluetooth signal, such as a notebook computer, a cellular phone, or a PDA, can be used as a life searching receiver to proceed with the rescue more quickly. Furthermore, as the Bluetooth signal is not interfered by an electromagnetic wave, and a Bluetooth application uses a low power, there will be no harm to a human body.

The I/O control unit 4 is composed of an input signal 40 for activating or deactivating the distress procedure, and an output signal 41 for transmitting the alarm and the distress signal.

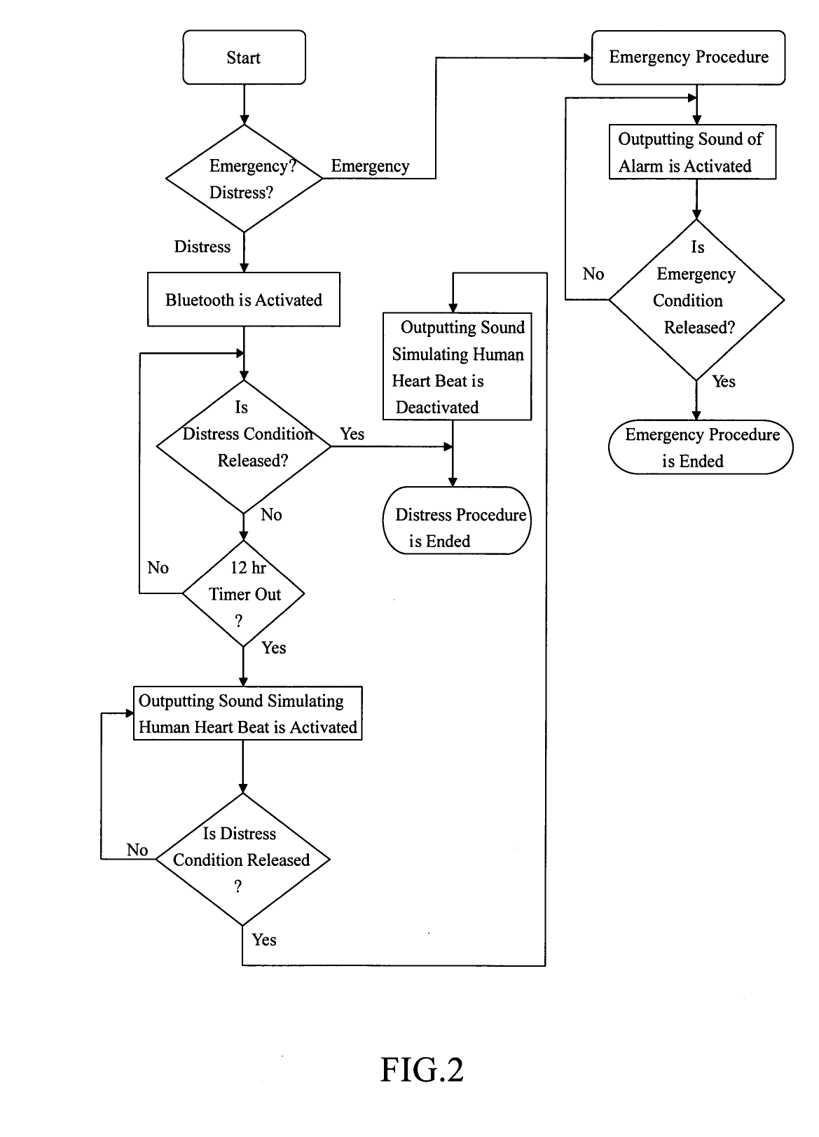

Referring to FIG. 2, in association with FIG. 1, first of all, when the input signal 40 is activated to turn on a switch of the distress procedure, an emergency procedure and the distress procedures will be initiated. For the emergency procedure, sound of alarm will be issued under control of the controlling CPU of the control unit 1, and a rigorous monitoring procedure is carried out. When the emergency condition is not released, the control unit 1 will control the sound of alarm to be continuously sent out.

At a same time when the emergency procedure is initiated, the distress procedure is initiated. At this time, the controlling CPU of the control unit 1 will trigger the Bluetooth chip of the Bluetooth signal control module 3 to operate on the bandwidth of 2.45 GHz for transmission, and as the signal design of the Bluetooth signal transmitter takes the 48-bit address specified by the IEEE 802 standard without requiring a pair matching, the messages can be connected by the one-to-one or one-to-many connection, with the transmission range as far as 10 m to 100 m. Any product, such as a notebook computer, a cellular phone, and a PDA, can be used as the life searching receiver, as long as that it is equipped with a device for receiving the Bluetooth signal.

The control unit 1 will, at the same time, proceed with a rigorous monitoring to the distress procedure. When the distress condition is released, the entire distress procedure will be deactivated. If the distress condition is not released in a certain fixed time, the controlling CPU of the control unit 1 will control and activate the low frequency heart beat simulator to generate the sound like a human heart beat, for allowing a rescue dog with a hearing range between 15 to 50,000 Hz, and a life detector to search for a victim, thereby gaining more survival chance for the victim.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A portable distress device with a bluetooth signal comprising a control unit, which is provided with a controlling CPU (Central Processing Unit) to control the entire distress device, wherein after an input signal which initiates a distress procedure is entered, a bluetooth signal control module is first controlled to transmit sound, images, and other related digital data, as well as to issue an alarm and a distress signal through an I/O (Input and Output) control unit; a power unit which supplies the power required by the entire distress device; the bluetooth signal control module, a bluetooth chip of which operating on a bandwidth of 2.45 GHz (Gigahertz) for transmission, and a signal transmitted by a bluetooth signal transmitter requiring or not requiring a pair matching, but taking a 48-bit address specified by the IEEE (Institute of Electrical and Electronic Engineers) 802 standard to connect a message by a one-to-one or one-to-many connection, such that any equipment which is equipped with a device for receiving the bluetooth signal is used as a life searching receiver; and the I/O (Input and Output) control unit, which is composed of the input signal that activates or deactivates the distress procedure, and an output signal that transmits the alarm and the distress signal.

2. The portable distress device with a bluetooth signal, according to claim 1, wherein in a certain fixed time after the distress device has activated the input signal, without releasing from the distress condition, the controlling CPU (Central Processing Unit) of the control unit will control and activate a low frequency heart beat simulator for generating sound like a human heart beat, under control of a timer.

3. The portable distress device with a bluetooth signal, according to claim 1, wherein the power unit is equipped with a design for displaying a low potential warning.
